(19) United States
(12) Patent Application Publication
(10) Pub. No.: US 2016/0030818 A1
(43) Pub. Date: Feb. 4, 2016

(54) Digital Memory Golf Green Repair Tool Systems

(71) Applicant: FINNdustries, LLC, Maricopa, AZ (US)

(72) Inventor: Paavola Dean, Maricopa, AZ (US)

(73) Assignee: FINNDUSTRIES, LLC, Maricopa, AZ (US)

(21) Appl. No.: 14/869,989

(22) Filed: Sep. 29, 2015

Related U.S. Application Data
(63) Continuation-in-part of application No. 29/496,966, filed on Jul. 18, 2014.
Application No. 29/496,966 is a continuation-in-part of application No. 14/534,165, filed on Nov. 5, 2014, now Pat. No. 9,168,440.

(51) Int. Cl. A63B 57/50; G06F 1/16; G06F 3/06

(52) U.S. Cl. CPC A63B 57/50; G06F 3/0679; G06F 1/1613

(57) ABSTRACT

An apparatus is provided which is capable of repairing a golf green as well as concealing an extensible and/or detachable electronic component. The electronic component comprises a digital memory device.

The present application is related to and claims priority to Design Patent Application No. 29/496,966, filed Jul. 18, 2014, and U.S. patent application Ser. No. 14/534,165, filed Nov. 5, 2014, which applications are incorporated herein by reference.

### FIELD OF THE INVENTION

The present invention relates generally to the field of electronic tool accessories and more specifically relates to a golf green repair tool having integrated electronic and digital components for providing multifunctional use.

### DESCRIPTION OF THE RELATED ART

In golf, maintaining the condition of a golf course is of prime concern, especially with the increased amount of play due to the growing popularity of the sport. One of the most important areas of the golf course is the putting green which must be maintained in near perfect condition so that the golf ball rolls true along the putting surface. Unfortunately the putting green is often damaged by foot traffic and ball impact damage.

In playing the game, the short range shot which comes to rest on the putting green is traditionally referred to as a pitch shot. As a result of the pitch shot, the golf ball often impacts the putting green with significant velocity, thereby creating an indentation. The indentation is traditionally referred to as a pitch mark, or commonly a divot. As a courtesy to those playing with or behind the player whose shot made the pitch mark, it is customary for that player to repair the divot using a handheld tool specifically designed to repair damage to golf course putting greens, the handheld device is traditionally referred to as a pitchfork. In order to maintain the condition of the course, players are urged to repair all divots that they notice or create during a round of play. Particular attention is urged with regard to the putting surface of the greens due to the sensitive nature of their effect upon a player's score. An immediate repair facilitates the natural recovery of the grass system which would otherwise dry out, preventing the grass root system from re-growing.

In order to facilitate the repair of putting green divots, various tools have been devised for golfers to carry and use. Divot repair tools are typically fork-shaped implements having tines that are pressed into the playing surface which can then be lifted or otherwise manipulated to restore its condition.

As is known, the game of golf has become a popular pastime for a great number of people. The popularity of the game has created opportunities for companies and charitable organizations, both public and private; to advertise their products, capabilities or cause. The organizations advertise and invite guests to a golf course for the purposes of social interaction and networking in the hopes of developing a business relationship or obtaining donations. The events, commonly known as “Golf Outings”, are where corporate sponsors customarily provide golf themed accessories with a specific logo or corporate insignia being prominently displayed thereon. Frequently corporate sponsors are interested in distributing electronic media (brochures, links to their Internet site, other visual media) at these outings. This advertising information has routinely been provided on “thumb drives” or USB flash memory sticks that have become ubiquitous due to their versatility and usefulness in the modern digital age.

Ideally, a golf green repair accessory should provide a digital memory for storage and ample room for advertising, and, yet would operate reliably and be manufactured at a modest expense. Thus, a need exists for a reliable digital memory golf green repair tool to avoid the above-mentioned problems.

### BRIEF SUMMARY OF THE INVENTION

In view of the foregoing disadvantages inherent in the known digital golf green repair tool art, the present invention combines the usefulness of the divot or putting green repair tool (pitchfork) and digital, preferably electronic flash memory into a single device.

The general purpose of the present invention, which will be described subsequently in greater detail, is to provide a multifunctional golf divot repair tool having an optional electronic component and a dial memory component for providing a versatile, handy, and conveniently accessible golf accessory for use when golfing.

The present invention further creates an opportunity for sponsors of a golf outing to offer a functional golf themed accessory that the recipient may use during the outing, as well as, on the go, at the home, or office. The present invention may incorporate both visual and electronic media onto a single device, thereby increasing the exposure to the strategically placed logo(s) and electronic corporate media that may have been stored onto the device memory.

A multifunctional digital memory golf green repair tool system is disclosed in a preferred embodiment comprising a divot tool body which may comprise a handle, a belt clip, at least one, but preferably at least two tines coupled to the bottom of the divot tool body, an electronic component integrated into the body, and a port coupled to the divot tool body and coupled to the electronic component providing access to the electronic architecture therein.

The divot tool body handle may have a top end, a bottom end, a right side, a left side, a front, and a back. The handle front may comprise a thumb-sized hollow indentation the ease in handling and manipulation of the divot tool body. Preferably, the port comprises to USB-compatible device.

In an alternative embodiment of the present invention, the electronic component may comprise a digital golf stroke counter assembly. The digital golf stroke counter assembly may comprise a display screen, a microprocessor, a plurality of control buttons, and at least one power source for powering the digital golf stroke counter assembly. The counter-microprocessor may be in communication with the control buttons and display screen, and the counter-microprocessor of the digital golf stroke counter assembly may be able to write a data file to the flash memory deice. The digital golf stroke counter assembly may be structured and arranged to enable a golfer to track golf strokes while playing a hole of golf. The electronic component may further comprise a GPS chip for tracking a relative location of the golf green repair tool to at least one golf-course-related point of interest.

Furthermore, the electronic component may comprise a radio-frequency identification (RFID) device. The RFID device may be structured and arranged to transmit and receive radio-frequency identification between the GPS chip and/or at least one golf-course-related point of interest. RFID may also be used without GPS, for instance, the RFID antenna may be pinged by an outside source (preferably a fixed golf location with audio capabilities) to activate an audio message, i.e. advertisement or information, at a specific location on the course, thereby creating an interactive golf experience.

The electronic component may further comprise an audio component. The audio component may comprise at least one micro-speaker located on the divot tool body. The audio component may be structured and arranged to play at least one audio file stored on the flash memory device.

It should be appreciated that during a round of golf, the digital memory golf green repair tool system may be useful for repairing divots on the golf course while providing a golfer with multifunctional tools useful during play.

Further embodiments include regulating various sizes of the digital memory access ports to conform with complimentary systems. A detented bezel may be included on the face to allow for manual score keeping. A hinged access, or slide may be used to display and extend memory systems that can be attached or removable.

The present invention holds significant improvements and serves as a digital memory golf green repair tool system. For purposes of summarizing the invention, certain aspects, advantages, and novel features of the invention have been described herein it is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, digital memory golf green repair tool systems, constructed and operative according to the teachings of the present invention.

FIG. 1 shows a perspective view according to an embodiment of the present invention.

FIG. 2 is an open perspective view of an embodiment of the present invention of FIG. 1.

FIG. 3 is a top exploded perspective view of an embodiment of the present invention.

FIG. 4 is a rear angular perspective open view of an embodiment of the present invention.

FIG. 5 is a perspective open view of an embodiment of the present invention.

FIG. 6A is a top view of an embodiment of the present invention.

FIG. 6B is an exploded view of an embodiment of the present invention.

FIG. 7A is a perspective view of an embodiment of the present invention.

FIG. 7B is a perspective of an embodiment of the present invention.

FIG. 8 is a perspective open view of another embodiment of the present invention.

FIG. 9 is an exploded view of an embodiment of the present invention.

FIG. 10 is a perspective view of an embodiment of the present invention.

FIG. 11 is a first-exploded view of an embodiment of the present invention.

FIG. 12 is a second-exploded view of an embodiment of the present invention.

FIG. 13 demonstrates another embodiment of the present invention.

FIG. 14 is as flowchart illustrating as method of use of an embodiment of the present invention.

FIG. 15 shows a perspective view of an embodiment of the invention.

FIG. 16 shows a perspective opened view of the embodiment of the invention shown in FIG. 15.

FIG. 17 shows a top opened view the embodiment of the invention shown in FIG. 15.

FIG. 18 shows a bottom perspective opened view of the embodiment of the invention shown in FIG. 15.

FIG. 19A shows a top view of the embodiment of the invention shown in FIG. 15.

FIG. 19B shows a side view of the embodiment of the invention shown in FIG. 15.

FIG. 20A shows a top view an embodiment of the invention.

FIG. 20B shows a side view of an embodiment of the invention.

FIG. 20C shows a bottom view of an embodiment of the invention.

FIG. 21A shows a top view of an embodiment of the invention.

FIG. 21B shows a bottom view of an embodiment of the invention.

FIG. 22A shows a side view of an embodiment of the invention.

FIG. 22B shows a perspective bottom view of an embodiment of the invention.

FIG. 23A shows an exploded view of the slide system of an embodiment of the invention.

FIG. 23B shows a bottom view of the slide of an embodiment of the invention.

FIG. 24 shows an exploded view of an embodiment of the invention.

FIG. 25A shows a top view of an embodiment of the invention.

FIG. 25B shows an opened perspective view of an embodiment of the invention.

FIG. 26 shows an exploded view of the embodiment of the invention shown in FIG. 25A-B.

FIG. 27 shows a partially exploded view of the embodiment of the invention shown in 25A-B.

The various embodiments of the present invention will hereinafter be described in conjunction with the appended drawings, wherein like designations denote like elements.

### DETAILED DESCRIPTION

As discussed above, embodiments of the present invention relate to a golf green repair tool and more particularly to a digital memory golf green repair tool which combines the usefulness of a divot or putting green repair tool and an integrated digital electronic flash memory into a single device. Alternatively, other sorts of small portable, low/no energy digital storage will suffice to practice the invention, including but not limited to secure digital (SD), solid-state drive (SSD), etc.

Generally speaking, a digital memory golf green repair tool system comprises a divot tool body comprising a handle. The handle may comprise a top end, bottom end, a right side, left side, front, and back. Directions of the ends (i.e. top, bottom, side, etc.) serve only to provide the relative position of each side, and in no way are to be understood to direct the appropriate use of the invention. At least one, but preferably at least two tines may be coupled to the bottom of the divot tool body. The divot tool body may comprise a hollow cavity for securely retaining an electronic component integrated into the divot tool body. A port may be coupled to the divot tool body and coupled to the electronic component thereby providing access to the electronic component. The divot tool body is useful for raising a divot in a golf green for leveling the golf green surface and also providing a user with digital memory storage via the electronic component accessible via the port. Preferably, the port comprises a USB-compatible device.

As shown, the divot tool body may comprise a thumb sized hollow indentation on the handle front. The thumb-sized hollow indentation may enable the user to ergonomically grip the handle and apply force with a thumb of a hand of the user when inserting the two tines into the golf green surface. Further, the thumb-sized hollow indentation on the handle front may assist the user in detaching and attaching a top element from a bottom element in an alternative embodiment of the present invention described herein.

In one embodiment of the present invention, the divot tool body may comprise a ball marker coupled to the handle front. The ball marker is useful for marking a location of a golf ball on a putting green when another player is putting. Furthermore, the ball marker may comprise a magnetic component for mating with a complementary magnetic component housed within the divot tool body. Alternatively a metallic ball marker may correspond to complimentary magnetic component, both including magnets, or other means of including attachment, including mechanical means such as boss and indentation/aperture, etc. The magnetic component is useful for enabling the user to magnetically attach and detach the ball marker to the divot tool body.

In one embodiment of the present invention, the divot tool body may comprise at least two separable elements, a top element and a bottom element. The top element may comprise the electronic component, the port, and a male mating coupler. The bottom element may comprise a female mating coupler for mounting the top element with the bottom element so as to join separable elements into the divot tool body.

In an alternative embodiment, the bottom element comprises the electronic component, the port, and a male mating coupler such that the top element comprises a female mating coupler for mounting the top element with the bottom element so as to join separable elements into the divot tool body.

In one embodiment of the golf green repair tool, the electronic component may comprise a flash memory device. The electronic component may further comprise a digital golf stroke counter assembly. The digital golf stroke counter assembly may comprise a display screen, a microprocessor, a plurality of control buttons, and at least one power source for powering the digital golf stroke counter assembly. The counter-microprocessor is in communication with the plurality of control buttons and the display screen. It should be appreciated that the digital golf stroke counter assembly is structured and arranged to enable at least one golfer to track golf strokes while playing at least one hole of golf.

Preferably, the display screen comprises a LCD, backlight LED or other display screen. Alternatively, the display screen may comprise a touch screen. During use, the digital golf stroke counter assembly is structured and arranged to be able to write a data file to the flash memory device. The data file may be displayable on the display screen, and stored for later use by the user.

The plurality of control buttons may be useful for controlling the digital stroke counter assembly. At least one of the control buttons comprises a button for counting a stroke on at least one hole of golf. At least one of the control buttons comprises a button for advancing to a new hole of golf and resetting the counter to 0. At least one of the control buttons may comprise a power button for powering on and off the digital stroke counter assembly. At least one of the control buttons may comprise an “execute” button for executing at least one command of the digital stroke counter assembly. Commands may include, but are not limited to, storing data files to the flash drive of the electrode component, deleting data files from the flash drive of the electronic component, re-writing data files, loading at least one data file, playing an audio data file, stopping an audio data file, advancing through data files, and the like.

In another embodiment of the present invention, the electronic component may comprise a GPS chip for tracking a relative location of the with green repair tool to at least one golf-course-related point of interest. The divot tool body may comprise a GPS switch located for enabling the golfer to selectively activate or deactivate the GPS chip. GPS-related data may provide a user with information about relative location on the course, including hole information distance from the pin, etc. Data on the course, such as hole, and pin information may be stored on board, i.e. on the flash memory component.

Furthermore, the electronic component may comprise an RFID device. The RFID device may be structured and arranged to transmit and receive radio-frequency identification between the tool and a one golf-course-related point of interest. The GPS chip and the RFID device may be powered by the power source powering the digital golf stroke counter assembly. Examples of golf-course-related points of interest include, but a limited to, golf pin location for each golf hole, clubhouse location, golf hole tee location for different player levels, bathroom location, restaurant or café location, and the like.

During use, the GPS device may be synced with a transmitter or transceiver device having GPS capability located at least one golf-course-related point of interest. In such as manner, the golf green repair tool is able to detect a maximum measurable distance between the divot tool body and the at least one golf-course-related point of interest. It should be appreciated that the golfer-user is able to toggle through various golf-course-related points of interest and select a particular golf-course-related point of interest via the plurality of control buttons and the distance may be displayed on the display screen of the digital golf stroke counter assembly. In such as manner, the golfer is able to determine a distance from his or her golf ball to the golf pin at any point in time during a round of golf.

During use, the onboard RFID may encompass either an on board antenna or emitter. In this embodiment, various locations on the course can be hard-wired to emit RFID. When the tool is passed by, the antenna reflects the signal and triggers the emitter, for instance, to provide audio information or advertisement. It can also alert the presence, timing and other information to the course management. In an alternative embodiment, an RF emitter may be powered and on-board the tool. In this embodiment, various antenna reflectors are positioned throughout the course to trigger varied pre-determined signals to the player, i.e. course information, advertisements and other location related information.

In another embodiment of the present invention, the electronic component may comprise an audio component. The audio component may comprise at least one micro-speaker located on the divot tool body. The audio component is able to play at least one audio data file, i.e. music file, storable on the flash drive of the golf green repair tool via the micro-speaker. Further, the audio component is able to read aloud golf scores, measured distances via the GPS chip, and other golf course related information.

In another embodiment of the digital memory golf green repair tool system, the divot tool body may further comprise a belt clip. The belt clip may be useful for attaching the digital memory golf green repair tool system to a belt or garter loop of the golfer. In such a manner, the golfer may be able to freely swing his or her golf club such that the digital memory golf green repair tool system does not interfere with his or her swing.

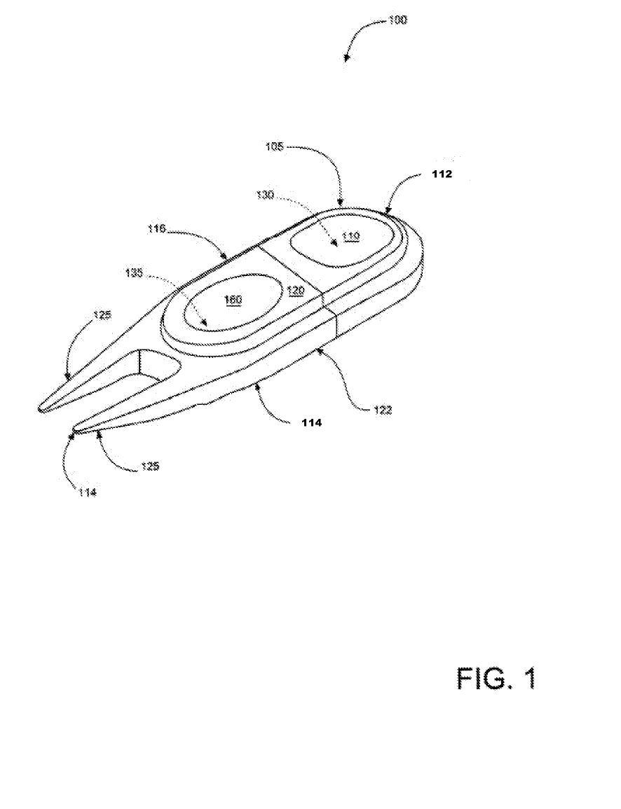

Referring to the drawings by numerals of reference there is shown in FIG. 1, a perspective view illustrating digital memory golf green repair tool systems 100 in a stored-position according to an embodiment of the present invention. As shown, digital memory golf green repair tool systems 199 may generally comprise divot tool body 105 having handle 119 for handling divot tool body 105. As shown in FIG. 1, handle 110 of divot tool body 105 comprises top end 112, bottom end 114, right side 116, left side 118, front 120, and back 122.

It should be appreciated that handle 110 may enable a golfer to handle divot tool body 105 in such a manner to be used as a divot repair tool for evening out a golfing surface (ie. smoothing divots on as putting green surface caused by approach shots).

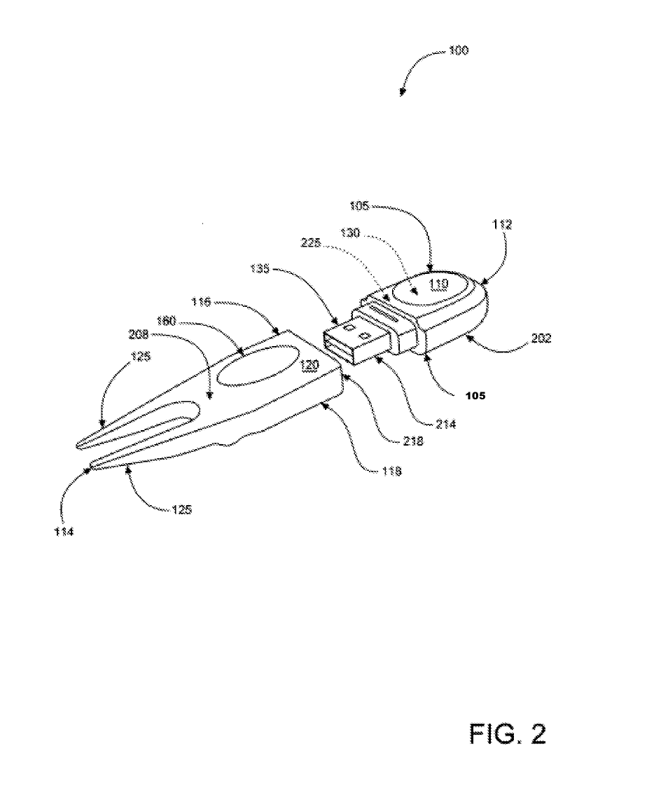

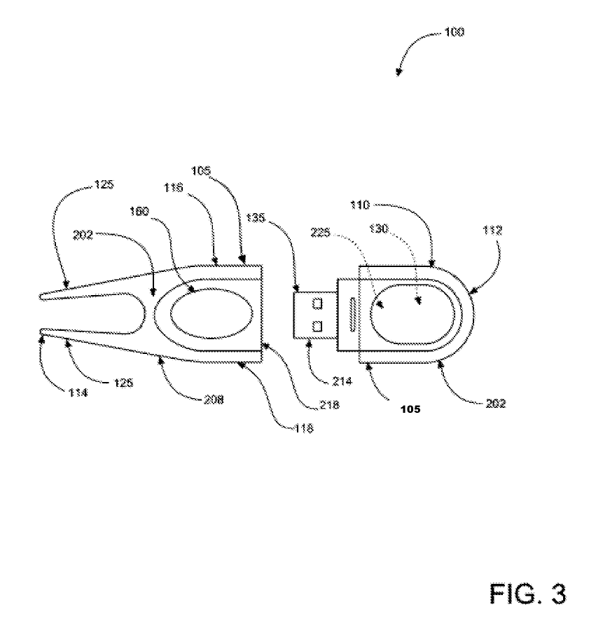

Referring now to FIGS. 2 and 3 showing perspective views illustrating digital memory golf green repair tool systems 100 in an open-position showing divot tool body 105 in two separable parts comprising top element 202 and bottom element 208 according to an embodiment of the present invention of FIG. 1. Digital memory golf green repair tool systems 100 may comprise divot tool body 105 comprising handle 110, two tines 125 coupled to bottom of divot tool body 105, electronic component 130 integrated into divot tool body 105 and port 135 coupled to divot tool body 105 and coupled to electronic component 130 for providing access to electronic component 130.

In referring to FIG. 3, a top perspective view is shown of divot tool body 105 having two separable elements; top element 202 and bottom element 208. In one embodiment of the present invention, top element 202 may comprise electronic component 130, port 135, and male mating coupler 214. Bottom element 208 may comprise female mating coupler 218 for mounting top element 202 with bottom element 208 so as to join the separated elements into divot tool body 105.

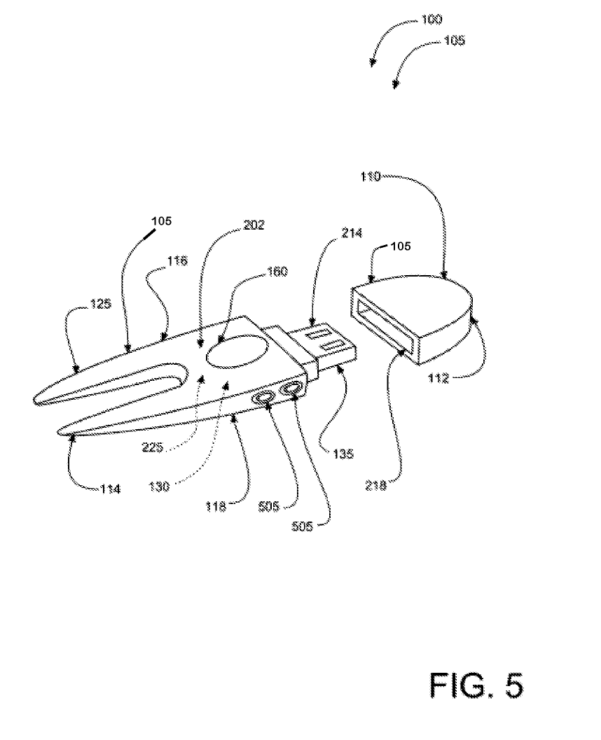

In another embodiment of the present invention similar to that shown in FIG. 5, bottom element 208 may comprise electronic component, port, and male mating coupler, while top element may comprise female mating coupler, as shown in FIG. 3, for mounting top element with bottom element so as to join separable elements into divot tool body 105. Electronic component 130 may comprise flash memory device 225. While this specification refers to microprocessor, let it be known that the electronic component and the term processor may refer to a microcontroller, microprocessor, and/or other electronic components and/or arrangements and/or list of elements known in the art to accomplish at least those relevant goals, processes, and/or features of any particular embodiment, as required. Nothing should be construed as to limit the terms microprocessor or processor, controller, counter, or component, to as single type, unless explicitly claimed as such. The electronics package can refer generally to a system with multiple parts, including chips with onboard power and/or memory, or simply refer to a single item, such as a memory chip, access channel, power supply, or as otherwise known in the art to accomplish the relevant goals, processes, and/or features of any particular embodiment, as required.

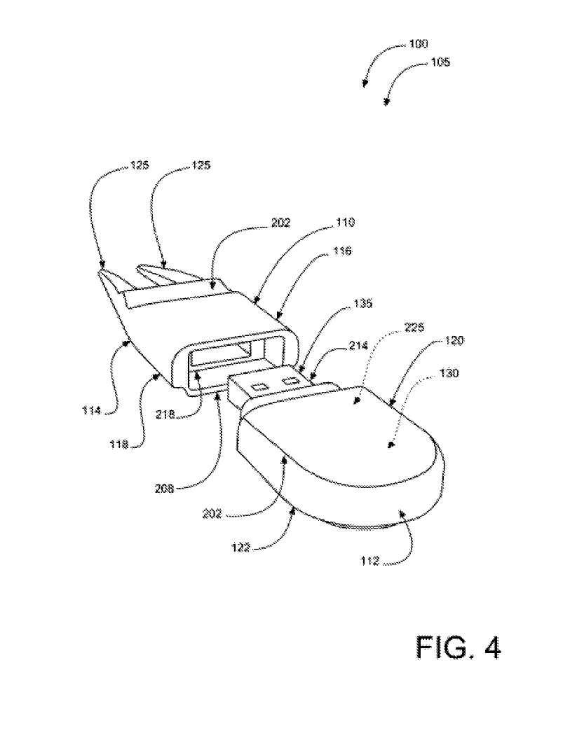

Referring now to FIG. 4 showing a rear angular perspective view depicting flash memory device 225 of digital memory golf green repair tool systems 100 according to an embodiment of the present invention of FIGS. 1-3. Port 135 of digital memory golf green repair tool systems 100 may comprise a USB-compatible device. Port 135 may be useful for inserting the USB-compatible device into a USB port on an electronic device (such as a computer, smartphone, and the like). In such a manner, golfer-user 140 may transfer data to and/or from the electronic device onto the flash memory device 225 via port 135.

Referring now to FIG. 5 showing digital memory golf green repair tool systems 100 comprising cable female plug-in port 505 accessible on an outside of divot tool body 105 according to an embodiment of the present invention. Cable plug-in 505 may be useful for communicating with a variety of external electronic devices and mobile devices having alternative plug-in methods to USB. This port may also be used to charge the on-board power source, preferably a rechargeable battery. Alternatively, port may be a micro-USB or other port known in the art, and may be used for re-charging on-board power battery.

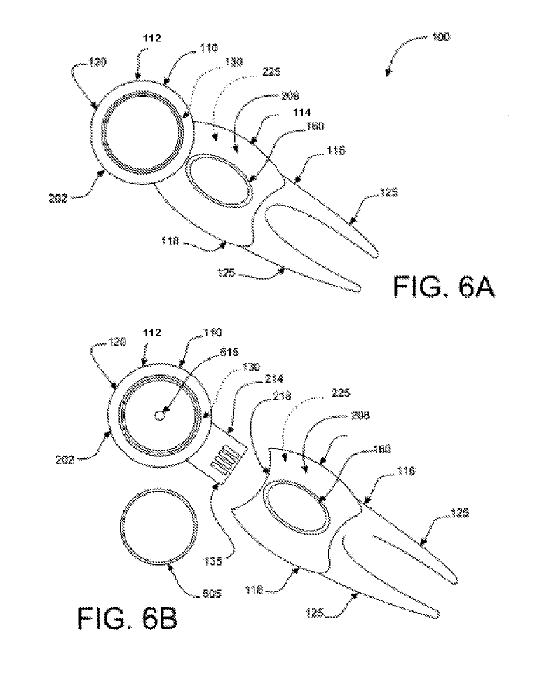

Referring now to FIGS. 6A and 6B showing digital memory golf green repair tool systems 100 comprising divot tool body 105 having ball marker 605 according to an embodiment of the present invention. Digital memory golf green repair tool systems 100 may comprise thumb-sized hollow indentation 160 on handle 110 front 120, and ball marker 605 coupled to handle 110 from 120. Thumb-size hollow indentation 160 on handle 110 may provide golfer with an ergonomic handling means for manipulating divot tool body during an ‘in-use’ condition. Ball marker 605 may be useful for placing on a putting green surface to mark the location of a golf ball during play.

Referring specifically to FIG. 6B showing ball marker 605 having magnetic component 615 for detachment and re-attachment of ball marker 605 according to an embodiment of the present invention of FIG. 6A. Ball marker 605 of digital memory golf green repair tool systems 100 may comprise magnetic components for mating with a complementary magnetic component housed within divot tool body 105 and marker 605. The magnet may be mounted on the interior of the tool body cavity for mating with a magnetic component/aspect of marker. The mounted magnet should be shielded to protect the on-board electronic components.

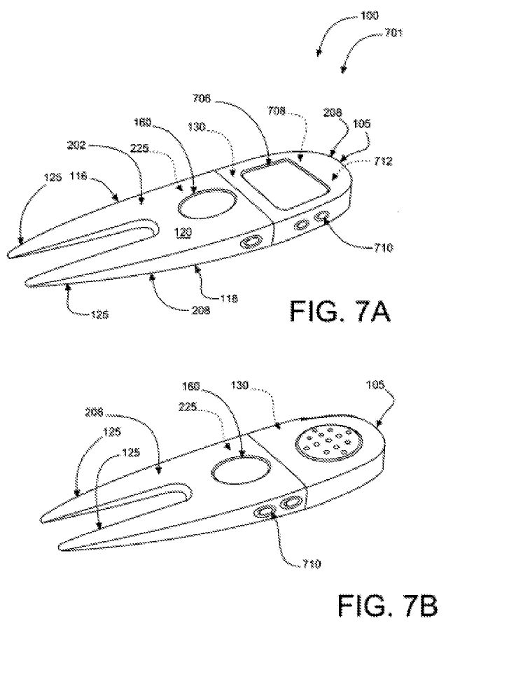

Referring now to FIG. 7A showing a perspective view illustrating digital memory golf green repair tool systems 100 comprising LCD display screen 706 located on a front of divot tool body 105 according to an embodiment of the present invention. As shown, electronic component 130 may comprise digital golf stroke counter assembly 701. In a preferred embodiment, digital golf stroke counter assembly 701 may comprise LCD display screen 706, microprocessor 708, a plurality of control buttons 710, and internal power source 712, such as e.g. a battery, capacitor, etc., for powering digital golf stroke counter assembly 701. Counter/microprocessor may be in communication with plurality of control buttons 710 and LCD display screen 706, and digital golf stroke counter assembly 701 may be structured and arranged to enable golfer 140 to track golf strokes while playing hole of golf. Counter/microprocessor of digital golf stroke counter assembly 701 may be able to write and read data file to flash memory device 225.

Referring specifically to FIG. 7B showing a perspective view illustrating digital memory golf green repair tool systems 100 comprising micro-speaker 820 located on a back of divot tool body 105 according to an embodiment of the present invention of FIG. 7A. Electronic component 130 may comprise audit component 816. As shown, audio component 816 may comprise micro-speaker 820 located on divot tool body 105. Audio component 816 may be structured and arranged to play audio file stored on flash memory device 225.

The device may also include an on-board microphone (not shown) to receive and store audio messages and files to allow for user input. A function button would allow for recording and stopping. Preferably, user would also be able to toggle through functions, and within function toggle through separate audio files. Foreseeably, the device could be used for audio journaling, or instruction. In this instance, it is preferred that the device contain an audio playback function through on-board speakers. As an alternative, the device can store unique audio files and later extract them from the digital audio by means of the USB or micro-USB port.

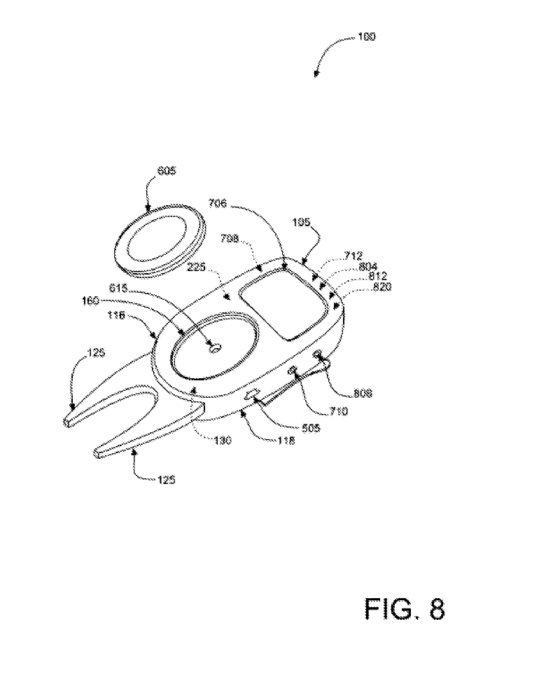

Referring now to FIG. 8 showing a perspective view illustrating digital memory golf green repair tool systems 100 comprising digital golf stroke counter assembly 701 integrated into divot tool body 105 according to another embodiment of the present invention. Electronic component 130 of digital memory golf green repair tool systems 100 may comprise GPS chip 804 for tracking a relative location of digital memory golf green repair tool systems 100 to a golf-course-related point of interest. Digital memory golf green repair tool systems 100 may further comprise GPS switch 808 located on divot tool body 105 for enabling golfer 140 to activate or deactivate GPS chip 804. Divot tool body 105 may comprise belt clip 825 such as for removable attachment to a belt loop or belt, etc.

Other additions to the electronic components may include an on-board pedometer. In this instance, the action buttons would allow for reset, setting pedometer and causing display of pedometer results on LCD screen. For the pedometer to work, the device would be clipped, or attached to the golfer user at some point where it may function, such as along a wrist, calf, on a shoe, etc.

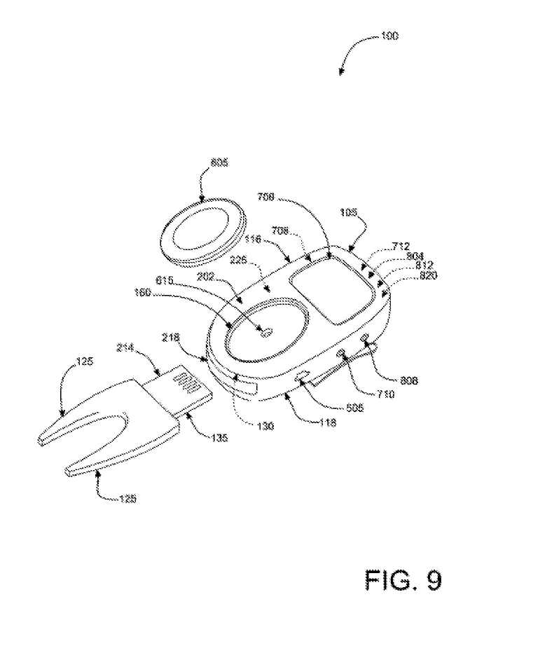

In referring now to FIG. 9 showing a perspective exploded view showing ball marker 605 and flash memory device 225 detachable from divot tool body 105 according to an embodiment of the present invention of FIG. 8. Electronic component 130 may comprise RFID device 812, RFID device 812 structured and arranged to transmit and receive radio-frequency identification between GPS chip 804 and golf-course-related point of interest 904. Memory, such as flash, or components may be located/embedded on either location, together or separately. For instance, in the removable end, or in the tine portion. When the memory is not hard-wired to the other electronic components, as in where the cap must be placed for the connection of memory to device components, a complimentary mating portion will allow for the on-board electronic to access the memory. In most embodiments, it is preferable to include the memory with the other on-board components to allow for various functionality. When size is paramount, working towards a smaller embodiment of the invention, it may become necessary to detach the memory and store it on as piece apart from other components.

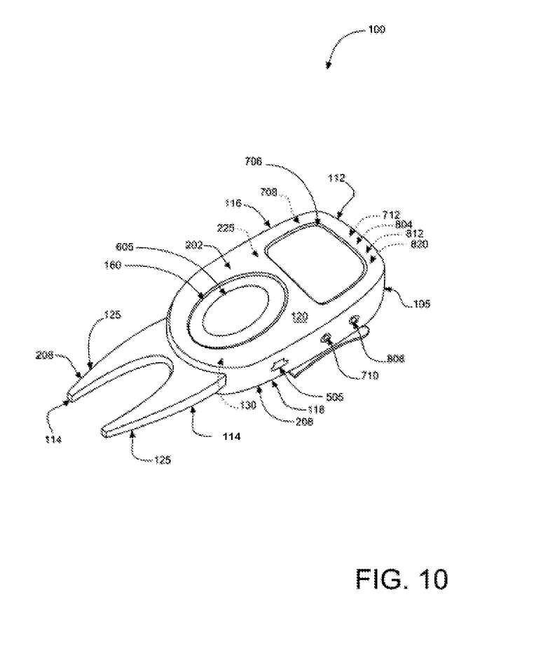

In referring now to FIG. 10 showing a perspective view illustrating digital memory golf green repair tool systems 100 comprising GPS chip 804 and RFID device 812 integrated into electronic component 130 of divot tool body 105 according to an embodiment of the present invention of FIGS. 8 and 9.

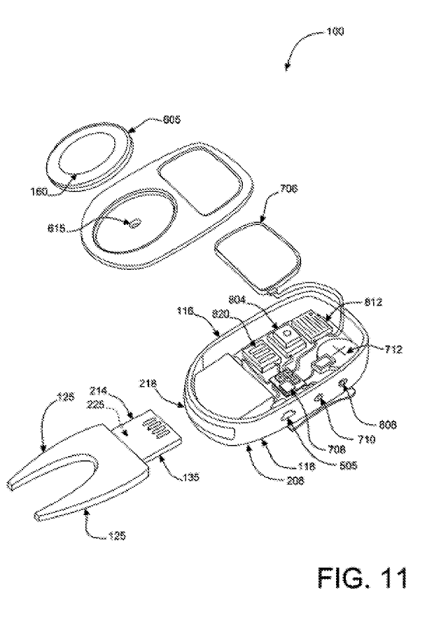

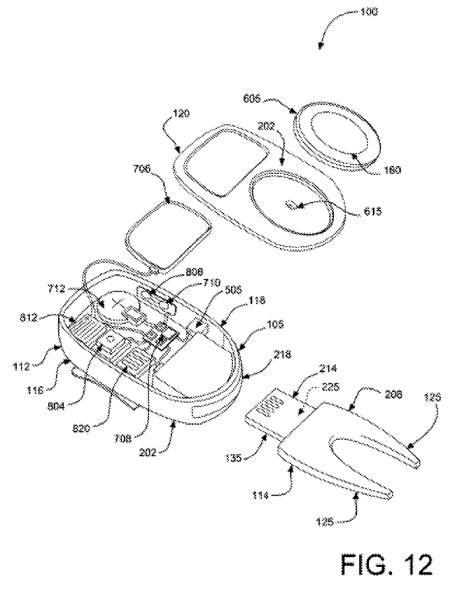

In referring now to FIGS. 11 and 12 showing a first-exploded view and a second-exploded view respectively illustrating components of digital golf stroke counter assembly 701 of digital memory golf green repair tool systems 100 according to an embodiment of the present invention of FIGS. 8-10. As shown, counter-microprocessor may be in communication with plurality of control buttons 710 and LCD display screen 706, and digital golf stroke counter assembly 701 via a plurality of circuitry cables. Further, RFID device 812 and GPS chip 804 may be in communication with power source 712 of digital golf stroke counter assembly 701 for providing operating power thereto.

Golf green repair tool systems 100 may be sold as a kit comprising the following parts: at least one divot tool body 105 comprising digital golf stroke counter assembly 701; and at least one set of user instructions. The kit has instructions such that functional relationships are detailed in relation to the structure of the invention (such that the invention can be used, maintained, or the like in a preferred manner). Digital memory golf green repair tool systems 100 may be manufactured and provided for sale in as wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

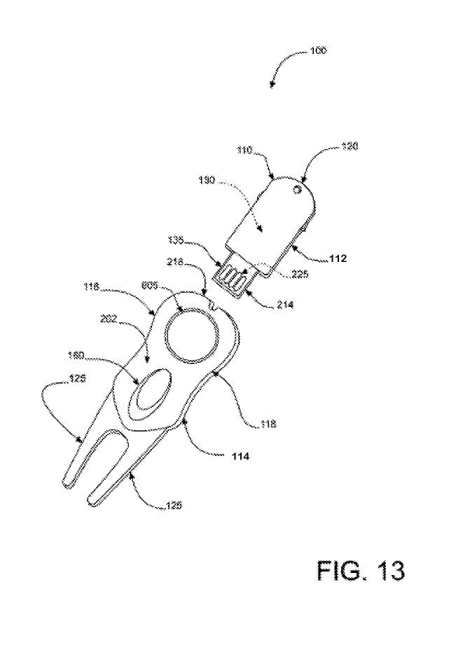

As shown in FIG. 13, data port 135, preferably USB, may be associated with the top end of the present invention. In this embodiment, the data port and preferably the memory component are housed in the top portion of the tool. Tool system 100 includes front end 120, right side 116, left sides 118, bottom end 114. Top element 202 may be shown to include tines 125. In the alternative, handle 110 may be referred to as a top end. Handle 110 includes hole 117 for attachment of a manual device, such as a string, rope, lanyard, key ring, etc. to allow for easier use and manipulation of handle 110 to remove from top end 112/top element 202. Conversely, these items may be referred to as bottom element 114 and bottom end 202. Male mating coupler 214 may be positioned on handle 110 with port 135 and requisite memory device 225 within handle 110. A ball marker 605 may be attached to top end or bottom end, depending on preference of user. When attached on top element 202, as shown, any attachment device may be suitable. It is preferred that in such embodiment, no further electronics are included on top element 202 and all electronic components, i.e. memory system and port, would be on bottom end 114.

When assembled (not shown) male coupler 135 may mate with female port 218 to form a closed system to protect sensitive ports. The purpose of this embodiment is to provide for as streamlined tool system with ease of access to on-board memory. In addition, electronic components in system 100 are housed on an end that is narrow and accessible to be taken apart from the total tool system and plugged into a standard computer port. The low/thin/narrow profile, along with manipulation handle and hole, make use of the device with most computer systems more manageable on a practical basis when other nearby ports on such a computer device are in use. In alternative embodiment (not shown) the top and bottom (handle and tine section) may be attached to one another at one or more (preferably two) articulable swivel joints, with a side panel displaced to allow for movement of any extending parts (i.e. male port), as know in the art. The user would then bend/open the tool providing access to the electronic port.

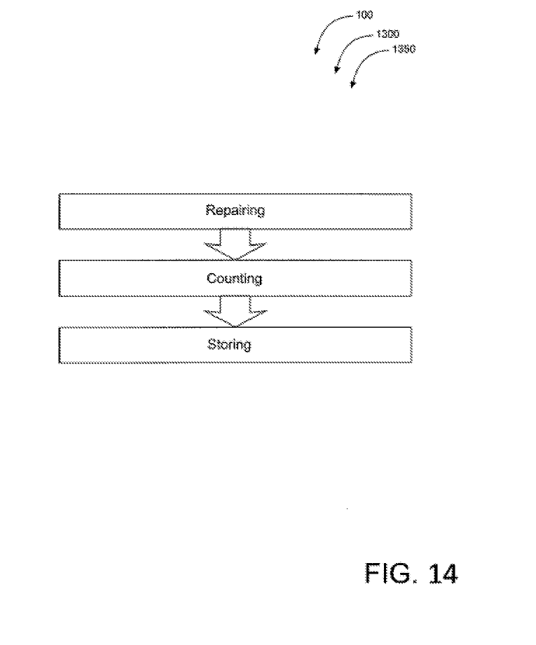

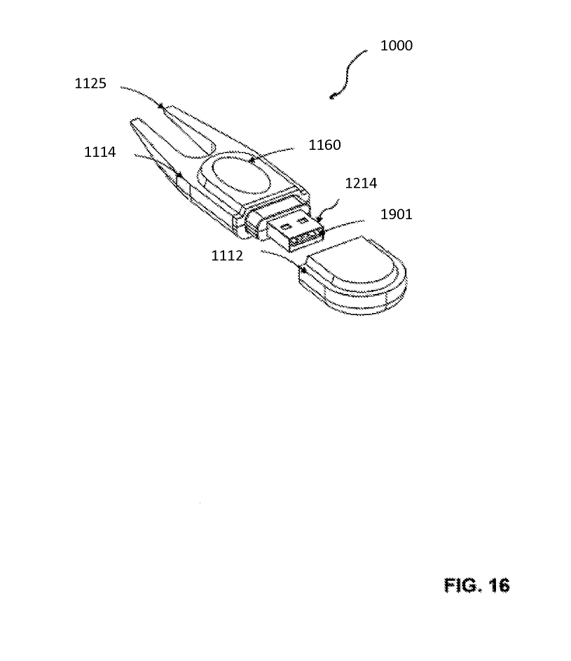

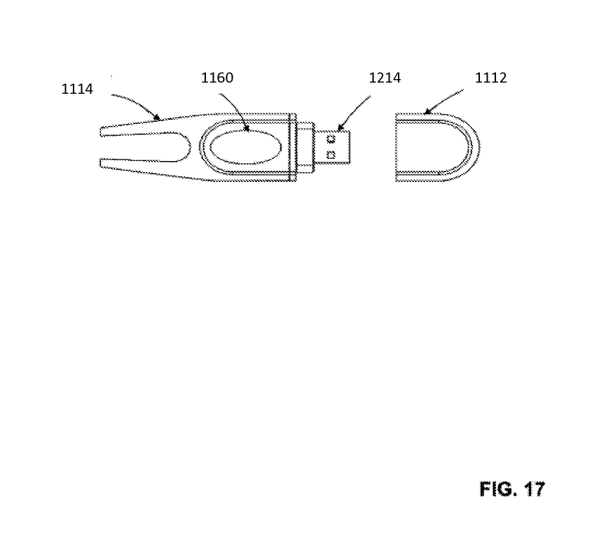

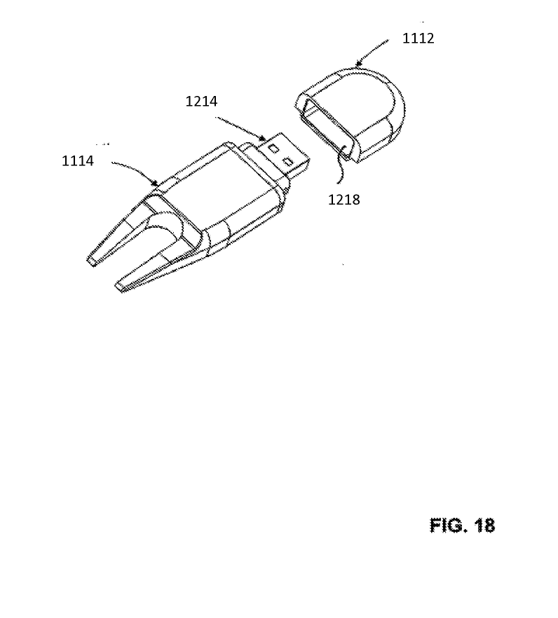

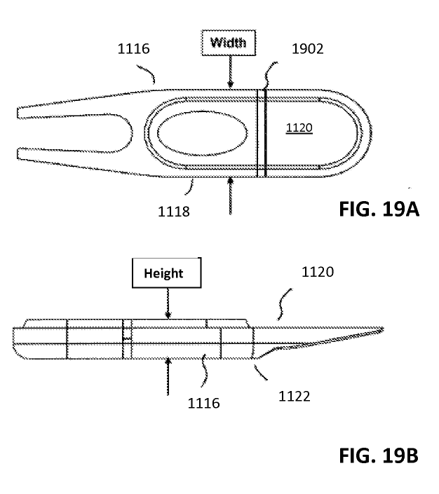

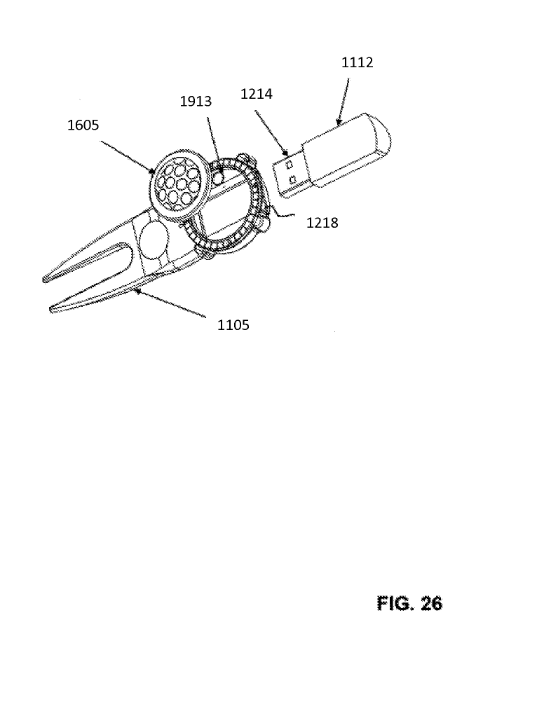

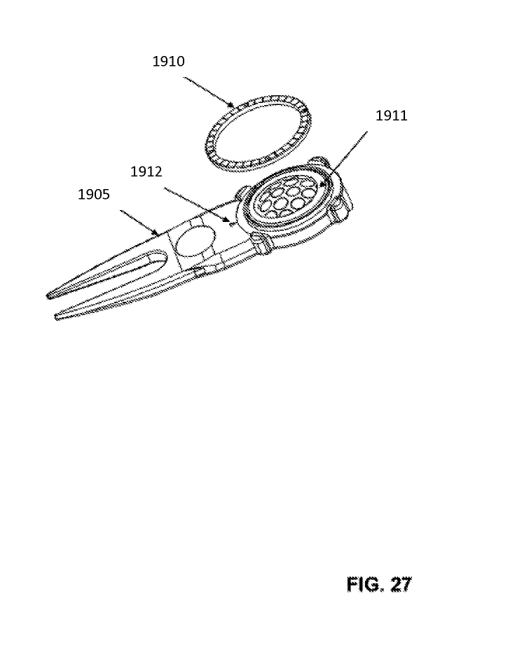

Referring now to FIG. 14 showing flowchart 1350 illustrating method of use 1300 for digital memory golf green repair tool systems 100 according to an embodiment of the present invention of FIGS. 1-27. As shown, method of use may comprise the following steps: step one, repairing a golf green surface via tines 125 of divot tool body 105; step two, counting golf stroke(s) via digital golf stroke counter assembly 701; and step three, storing at least one data file on flash memory device 225 for use with USB-compatible electronic device.

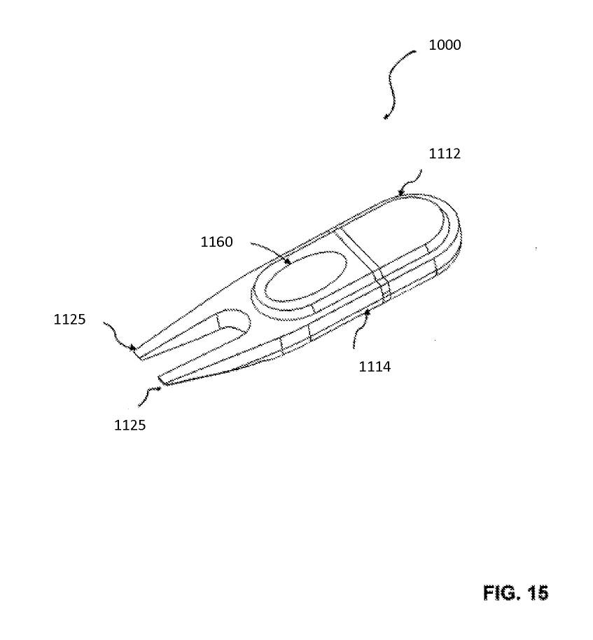

Referring to FIGS. 15-19B, digital memory golf green tool system 1000, includes bottom end 1114 and top end 1112, thumb indentation adapted for use by a user's hand and fingers/thumb, and tines 1125. Male mating coupler port 1214 contains USB electronics, in this embodiment a UDP chip 1901. Male port 1214 fits into female mating port/chamber 1218. System 1000 includes a right side 1116 and left side 1118, and a midline 1902 at the point where top end 1112 and bottom end 1114 meet. A width is defined at the midline and provides a limit as to the complementary devices the compatible with the system. Height is also defined where front 1120 and back 1122 are separated at midline.

Preferably, body is manufactured with a plastic mold, as either one or separable plastic pieces as is known in the art (e.g. front back panels mating). The width is preferably narrow enough to use with complementary features on a standard PC, or other USB compatible devices, e.g. so as a not to block the adjacent USB port on a computer. Preferably, width is less than 1.5 inches, and most preferably about 1.3 inches or less, down to the width of the USB flash device, e.g. UDP, as low as 1.2 cm or even 1 cm, or as known in the art. The height is also very low less than 1.3 inches, as low as 0.45 cm for a standard USB port, but may be even less, given the possible height of UDP chips now, or as developed in the future. Standard sizes for the memory system mounted or unmounted may be 0.625 inches by 1.125 inches, or 0.625 cm by 1.125 cm, whereas an unmounted can be 0.5 inches by 1.125 inches or even as small as 0.75 cm by 1.125 cm. Preferably digital memory accessible component with width of less than 2.0 cm or even less than 1.5 cm.

Another embodiment of the present invention may include a divot tool formed with a soft touch rubber over-molding. An encased surface mounted flash memory, or non-surface mounted memory retractable, may be enclosed in the body. The flash memory board may be implanted with an LED positioned within the cavity of a premolded fine/body. The assembly then placed into a mold shell which retains the relative position of the parts until the rubber is introduced. Soft rubber may then be injected into the cavity of the times filling all of the empty space around the memory board, as well as an optional thumb depression. The tooling insures that the LED is exposed at the center of the thumb depression so that light can be seen while the USB is working. A single built in sliding button can be used to extend the electronic components, the button on the front face. Hard tines (e.g. plastic or metal) may be over-molded with rubber. Further electronic components may also be included such as LED light and other system complimenting or separate from the flash memory device. The rubber can be injected into a mold containing the hard tines, thus encasing and trapping the surface mount style flash memory.

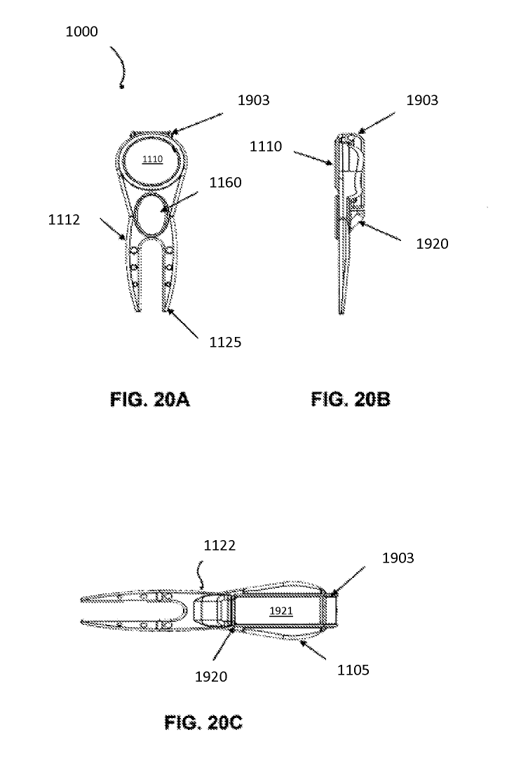

Referring to FIGS. 20A-22B, an extendable embodiment of system 1000 is possible, to utilize a non-surface mounted memory design—where no metal shell is required around the USB port or flash memory device to mate with a female USB port. Bottom end 1112 runs the length of the collapsed mode shown in in FIG. 20. Thumb indent 1160 may be included on front 1110 of body 1105, along with times 1125. Hinge 1903 forms on the end opposite the tines on body 1105 to contain flip top 1921. Flip top 1921 is secured by clasp 1920 on back 1122. Ball marker 1605 may alternatively be included on front 1110. Tine surface features 1126, such as indentations or decorations may be used for purely ornamental purpose, and/or to add surface features such as ergonomic or ease of use in green.

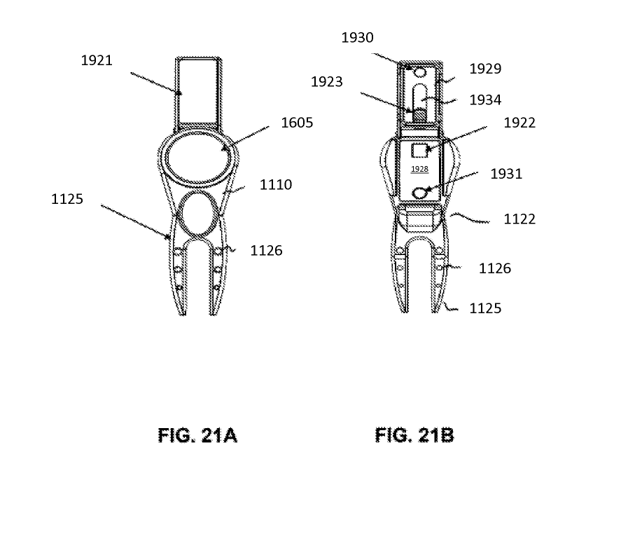

Flip top 1921 can be extended, as shown in open mode in FIGS. 21A-B. Flip to 1921 may include underside 1929 with features to clasp and access on board electronic component(s). Flipping magnet 1930 on flip top underside 1929 may be used to secure flip tip 1921 when closed with complimentary securing magnet 1931 on hidden surface 1928 on back 1122. Recess 1922 allows for space to allow button 1923 when closed. Button is included in slot 1934. As shown in FIG. 21B, button 1923 is in down position at bottom of slot 1934.

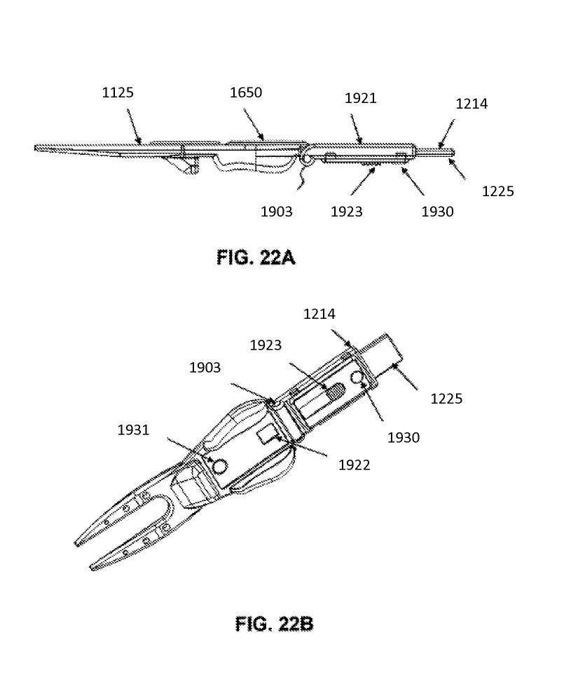

Shown in FIGS. 22A-B, system is in open mode and electronics are extended. Flip top 1920 is open, and button 1923 is pushed up to allow port 1214 to extend with flash memory device 1225, such as UDP, extended outward for access.

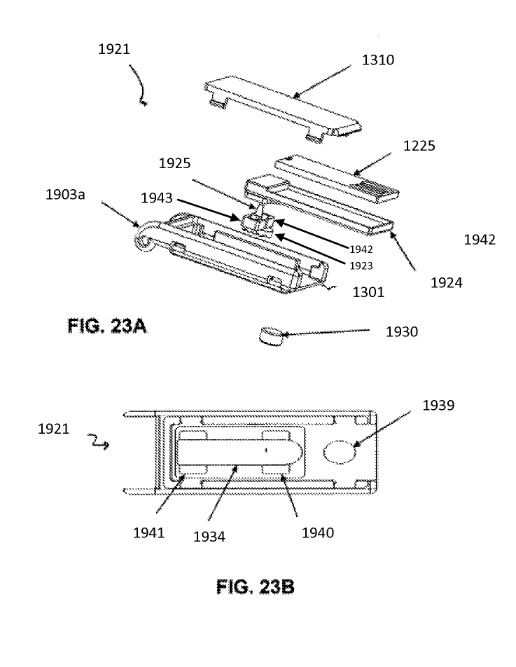

For one alternative embodiment, button details for sliding tray and memory assembly is shown in FIGS. 23A-B. Flip top 1921 includes lid 1310 enclosing memory device 1225 over tray 1924 with open end to allow for extension. Button 1923 preferably included detented shoulders 1942 and 1943 in slot 1934 and may be spring loaded by spring 1925, and fits into flip top body 1301. Flip top body 1301 also includes recessed space 1939 for magnet 1930. Preferably, as shown in underside of flip top 1921 in FIG. 23B, slot 1934 includes depressions 1940 and 1941 for button detents 1942/1943 for locking in extended and retracted positions.

The UDP may be held down by a male protrusion in the slide tray, and a backstop may be included to prevent the chip from sliding backward. Typically a USB shell also provides to prevent forward and sideward motion, which can be accomplished in flip top without shell.

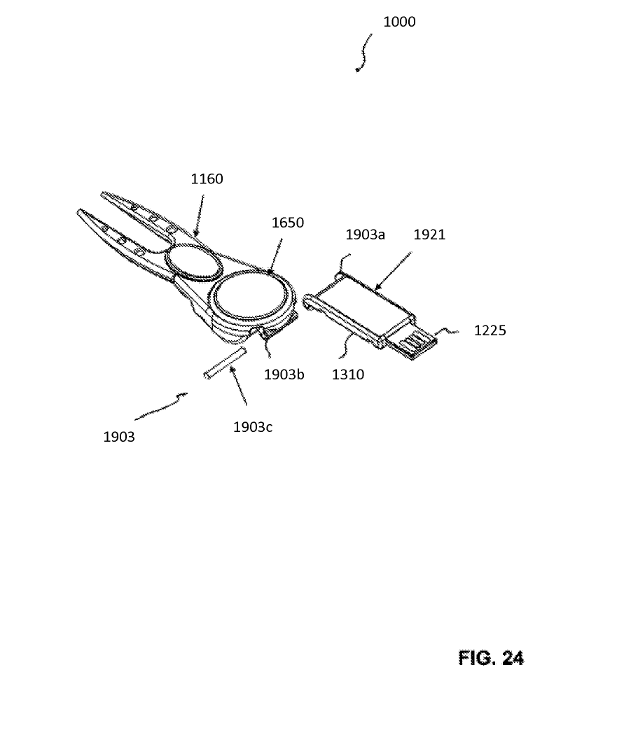

As show in in FIG. 24, system may include optional thumb indent 1160 and ball marker 1650. Hinge 1903 may include channel 1903b for pin 1903c to fit through complimentary apertures 1903 in hinge, whereby apertures 1903a are preferably on flip to 1921 housing lid 1310 and electronic component 1225.

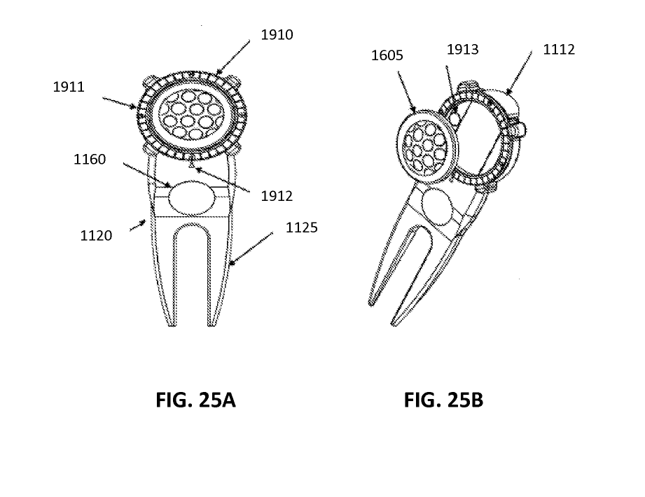

As shown in FIGS. 25A-27, an alternative embodiment may include a detented bezel for score keeping, such as strokes over/under par. Again, optional thumb indent 1160 is shown, as are tines 1125. Dial bezel 1910 includes markings for manual score keeping. Dial 1910 fits in track 1911, and may be spring loaded with spring 1913 to positively align the score markings of the bezel to the mark (e.g. arrow) of the times section to indicate score as bezel is turned. Permanent notation, such as mark 1912 may be on front 1120. Inside dial bezel 1910, may be a detachable ball marker 1605. Ball marker may be magnetic, or contain a magnet to match/mate with mounted magnet otherwise hidden by marker 1605.

Top end 1112 may detach from body 1105 may include the male port 1214 housing electronic components, such as memory device, and fit within female recess 1218.

An electronics component and package may refer to the relevant portions of the system for a specific embodiment described above. While flash memory is disclosed as a primary preferred embodiment, any digital memory device known now, or in the future, that can be adapted for use within the structure and systems disclosed herein are contemplated.

1. A digital memory golf green repair tool system comprising:
a divot tool body having at least two separable sections, a top section and a bottom section, whereby said top section and said bottom section are coupled together via male/female USB shaped ports;
said top section comprising:
at least two tines adapted to repair a golf green surface;
a cavity adapted to provide for housing a USB male port comprising the female shaped port; and
a top section outer surface comprising a face surface, said face surface comprising an indentation adapted for a thumb; and
said bottom section comprising:
a fixed USB male port adapted to mate with said top section cavity;
a bottom section outer surface face for adjacently mating with said top section face surface when top section and bottom section are mated.

2. The digital memory tool of claim 1, wherein said fixed USB male port houses an electronics package.

3. The digital memory tool of claim 2, wherein said electronics package comprises a digital memory device coupled to said USB male port.

4. The digital memory tool of claim 3, wherein said electronics package comprises a digital memory device mechanically coupled to said USB male port.

5. The digital memory tool of claim 1, wherein said top and bottom sections coupled at a midline, and wherein said top and bottom sections comprise an outer width defined by the width at said midline, wherein said outer width is less than 1.125 inches.

6. The digital memory tool of claim 1, wherein said top and bottom sections coupled at a midline, and wherein said top and bottom sections comprise an outer width defined by the width at said midline, wherein said outer width is less than 2 cm.

7. A golf green repair tool comprising
a divot tool body;
said divot tool body comprising at handle;
at least one tine coupled to said bottom of said divot tool body;
an electronic component; and
a detented bezel rotatably mounted on said divot tool body, said detented bezel comprising markings adapted to allow manual score keeping.

8. The golf green repair tool of claim 7, further comprising:
a port coupled to said divot tool body and coupled to said electronic component providing access to said electronic component.

9. The golf green repair tool of claim 8, where said electronics component comprises a flash memory device.

10. A digital memory golf green repair tool comprising:
a divot tool body having at least two hinged sections, a flip top section and a bottom section, whereby said flip top section and said bottom section are coupled together via hinge;
said bottom section comprising:
at least one tine adapted to repair a golf green surface;
said flip top section comprising:
a digital memory device;
a slide tray housing said digital memory device to allow extension and retraction of a memory device.
